(19) United States
(12) Patent Application Publication
(10) Pub. No.: US 2004/0058305 A1
(43) Pub. Date: Mar. 25, 2004

(54) Apparatus for performing and training CPR and methods for using the same

(75) Inventors: Keith G. Lurie, Minneapolis, MN (US); Todd M. Zielinski, Minneapolis, MN (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CPRx LLC, Eden Prairie, MN

(21) Appl. No.: 10/255,319

(22) Filed: Sep. 25, 2002

(51) Int. Cl. G09B 23/28

(52) U.S. Cl. 434/265

(57) ABSTRACT

In one embodiment, a CPR training device comprises a flexible structure which is configured to simulate a human chest, and a pressure sensor. The pressure sensor is disposed within the flexible structure and is configured to sense pressure within the flexible structure. Both positive and negative pressures relative to the ambient or atmospheric pressure can be determined by the pressure sensor.

### CROSS-REFERENCES TO RELATED APPLICATIONS

This application is also related to but does not claim priority from U.S. patent application Ser. No. 09/854,238, filed May 11, 2001, which is a continuation in part application of U.S. patent application Ser. No. 09/546,252, filed Apr. 10, 2000, which is a continuation of U.S. patent application No. 08/950,702, filed Oct. 15, 1997 (now U.S. Pat. No. 6,062,219), which is a continuation-in-part application of U.S. patent application Ser. No. 08/403,009, filed Mar. 10, 1995 (now U.S. Pat. No. 5,692,498), which is a continuation-in-part application of U.S. patent application Ser. No. 08/149,204, filed Nov. 9, 1993 (now U.S. Pat. No. 5,551,420), the disclosures of which are incorporated herein by reference in their entirety.

### FIELD OF THE INVENTION

This invention relates generally to the field of cardiopulmonary resuscitation (CPR), and in particular to apparatus and methods for training potential rescuers in CPR techniques. More specifically, the present invention provides devices and methods for measuring intrathoracic pressures while training potential rescuers in CPR procedures.

### BACKGROUND OF THE INVENTION

Sudden cardiac arrest is a major cause of death throughout the world. This has prompted the development of a variety of CPR procedures to restore cardiac function for those suffering from cardiac arrest. Probably the most widely used CPR procedure is often referred to as standard CPR. With standard CPR, one or both hands are placed onto a patient's chest, and pressure is applied to repeatedly compress the chest with a generally constant rhythm. Another CPR technique is where a patient's chest may be actively lifted in an alternating manner with chest compression. This technique is often referred to as active compression/decompression (ACD) CPR. This technique is described generally in U.S. Pat. Nos. 5,645,522, 5,551,420 and 5,692,498, the complete disclosures of which are herein incorporated by reference.

To enhance the benefits of CPR, it is desirable to perform the CPR procedure in such a manner so as to create or simulate certain intrathoracic pressures within the patient at certain time intervals. This can be accomplished, for example, by controlling the rate and distance of chest compressions and/or decompressions/elevations or monitoring the intrathoracic pressure during compressions and decompressions.

In some parts of the world, little or no training is provided relating to the proper manner of performing chest compressions. In other areas of the world, life-size mannequins have been utilized to train in the performance of CPR. One disadvantage of utilizing mannequins in training procedures is that they do not provide adequate feedback on the technique being used by a trainee, particularly when the trainee is using ACD CPR techniques where the chest is actively lifted in an alternating manner with chest compressions.

During the compression stage of CPR blood flows out of the heart chambers, and during the decompression stage blood flows into the heart chambers. One of the most common mistakes a person makes during CPR administration is that not enough time is given for the decompression period, thus resulting in an insufficient blood flow into the heart chambers prior to the next compression stage.

The present invention provides systems, devices and associated methods to provide more effective training for CPR procedures. The systems and devices of the present invention provide relevant and timely feedback, such as the pressure within the intrathoracic space during CPR administration.

### SUMMARY OF THE INVENTION

In one embodiment, the present invention provides systems, devices and methods for measuring intrathoracic pressures while training potential rescuers in CPR procedures. The training devices of the invention may comprise a flexible structure and a pressure sensor that is disposed within the flexible structure and is configured to sense the pressure within the flexible structure. The pressure sensor is configured to sense both positive and negative pressures relative to the pressure within the flexible structure when the flexible structure is at rest or relative to the ambient or atmospheric pressure. In one aspect, the flexible structure has an opening that is in fluid communication with a valve system that is designed to control or regulate fluid inflows and outflows to help simulate pressure changes that would normally be experienced within a human patient's chest during CPR procedures.

In another aspect, the flexible structure may be coupled to a human mannequin, thereby more realistically representing a patient. In such cases, the flexible structure is typically located within the chest cavity area of the mannequin.

In some cases, the valve system may be incorporated into the mannequin, or simply coupled directly to the flexible structure. A variety of attachment devices may also be used to couple the valve system to the mannequin. For example, the valve system may be coupled to a face mask, an endotracheal tube or the like. In addition to, or as an alternative, the valve system may be used to enhance or augment negative and/or positive intrathoracic pressures during CPR training a manner similar to that described in U.S. Pat. Nos. 6,062,219; 5,692,498; and 5,551,420, previously incorporated by reference. In some cases, two valve systems could be used, one to simulate normal chest pressures, and one to augment pressures.

The invention may also utilize a controller to process signals from the pressure sensor. A display screen may be coupled to the controller to display pressures produced during training. In some cases, the controller may include hardware and/or software to alter the incoming pressure signals so that they more realistically reflect pressures that would be generated during training. This alternation may be based on empirical data from human patients.

In another embodiment, the invention provides a CPR training device that comprises a portable carrying case having a control or operator feedback compartment and a compression compartment. A flexible compression platform or diaphragm is positioned over the compression compartment, and an inflatable or pre-inflated bladder disposed beneath the compression platform. A source of gas or other inflation device may be provided to permit the bladder to be inflated with pressured gas, if needed. In some cases, the bladder may be permanently inflated. Hence, the device may be used in CPR training by simply opening the carrying case and inflating the bladder if needed, to cause the compression platform to expand and assume the shape of the human chest or, more simply, to the shape of a rectangular cube. Conveniently, a diagram or figure may be included on the compression platform that depicts anatomical regions of a body, such as the thorax.

The training device can be used in association with an adjunctive CPR device that can be secured to the compression platform. Alternatively, the assistance device can be adhered to, coupled to, or placed in contact with the compression platform. In this way, the assistance device can be employed to press down on the compression platform as well to actively lift the compression platform, e.g., when performing ACD CPR.

In one embodiment, the compression compartment includes a compression cavity into which a pressure, force or excursion sensor is placed. The compression cavity protects the pressure or other sensor from the inflated bladder while still permitting the sensor to sense the pressure or other characteristic within the compression compartment. A pressure display may also be provided on the control compartment to display the pressure or other characteristic sensed by the sensor. In this way, pressures may be monitored and displayed both during active compression and/or active lifting of the compression platform. In another aspect, a distance or excursion sensor is provided to sense the distance at which the compression platform is raised and/or lowered relative to a baseline position. A distance display may be provided on the control platform to display the measured distance. In this way, a trainee is able to visualize the distance in which he or she is compressing the platform or actually lifting the compression platform. A force sensor may also be employed to sense the forces acting on the compression platform.

Yet in another aspect, a spring-biased piston is disposed in the compression compartment, with the bladder surrounding the piston. With the bladder inflated, the pressure and tension on the bladder simulates the tension of a human thorax during chest compressions and the recoil properties of a human thorax during chest decompressions or elevations. The spring-biased piston provides for additional simulation of human thoracic tensions and recoil properties. Conveniently, the distance sensor may be configured to sense the distance traveled by the piston in both the downward and upward directions.

The training device can also be provided with a power supply that is disposed in the control compartment. For example, the power supply may comprise a rechargeable battery to permit the training device to be used in the field. In still yet another aspect, a metronome may be provided to assist in the performance of regular compressions and/or decompressions/elevations of the compression platform. An alarm may also be provided to produce audio and/or visual feedback if the compression platform is compressed or decompressed at a rate outside of a certain range and/or if the compression compartment is pressed or elevated more than a certain distance.

Still in another aspect, the device can include a lung bladder and a length of tubing to permit a rescuer to simulate patient ventilation while performing CPR. A sensor may be used to sense when intrathoracic pressure (i.e., ITP) increases when a ventilation is provided so that feedback may be given as to the quality and timing of the ventilations.

Yet still in another aspect of the present invention, the feedback system comprises information on the pressure within the compression compartment when the chest is being compressed and/or elevated. This pressure represents positive or negative intrathoracic pressures that would be created in a human patient when performing standard manual and ACD-CPR. An audio and/or visual alarm can also be operatively connected to alert the person administering CPR when the pressure within the compression compartment is outside of a certain range when pressing and/or lifting the compression platform. The feedback can also include information on the distance at which the compression platform is pressed or elevated. Optionally, an audio and/or visual alarm can be produced if the distance measured is outside a certain range when pressing and/or lifting the compression platform.

During training, the user can place one or more hands onto the compression platform in a manner similar to that used when performing standard CPR. As previously described, an assistance device can be coupled to the compression platform, with an adjunctive CRP device being used to press or actively lift the compression platform.

In one aspect, the sensor can be connected to a computer interface to provide a permanent record various feedback information, such as the changes in intrathoracic pressure when CPR is performed. Other sensor can also be operatively attached to the device to assess other feedback information, such as the excursion distance and the rate of excursion.

Devices of the present invention can also include an air flow sensor within the simulated endotracheal tube of a mannequin that is used in training CPR procedures. In this manner, effectiveness of mouth to mouth resuscitation technique can also be monitored. In particular, the air flow sensor can determine the flow rate of the air passing through the simulated endotracheal tube. The signal (e.g., electrical signal) that is generated by the air flow sensor is then transmitted to a display. The air flow sensor can comprise a flexible member having a material with an electrical resistance that changes upon bending of the flexible member. In this way, a controller can be employed to detect a voltage change that is proportional to the flow rate.

### BRIEF DESCRIPTION OF THE DRAWINGS

FIG. 1 is a schematic side view of a CPR training device comprising a flexible structure and a pressure sensor according to one embodiment of the present invention.

FIG. 2A illustrates the CPR training device of FIG. 1 incorporated into a mannequin.

FIG. 2B illustrates the mannequin of FIG. 2A with an airway and an endotracheal tube having a valve system according to the invention.

FIG. 2C illustrates the mannequin of FIG. 2A with an airway and a facial mask having a valve system according to the invention.

FIG. 3 is a front view of a CPR training device according to another embodiment of the present invention.

FIG. 4 is a side view of the CPR training device of FIG. 3.

FIG. 5 is a top view of the CPR training device of FIG. 3.

FIG. 6 is a top view of a compression compartment of the CPR training device of FIG. 3 with a compression platform being removed.

FIG. 7 is a cross-sectional front view of the compression compartment of FIG. 6.

FIG. 8 illustrates a spring piston of the compression compartment of FIG. 7 as shown in an elevated position.

FIG. 9 illustrates the spring piston of FIG. 8 when in a compressed position.

FIG. 10 is a top view of a kneel plate of the training device of FIG. 3 when in an extended position.

FIG. 11 illustrates the kneel plate of FIG. 10 in a retracted position.

FIG. 12 is a more detailed view of a control panel of the CPR training device of FIG. 3.

FIG. 13 illustrates a flow chart setting forth the steps of one method for training in the use of CPR according to the invention.

FIG. 14 is a top view of an alternative training device according to the invention.

FIG. 15 is a cross sectional side view of the training device of FIG. 14.

### DETAILED DESCRIPTION OF THE INVENTION

The present invention provides devices, systems and methods for training, educating and tracking individuals in the performance of CPR. The invention can be utilized in conjunction with most generally accepted CPR methods, including standard CPR where the rescuer places his or her hands on the chest and repeatedly presses down to compress the chest. The invention is also useful with ACD CPR techniques where the chest is lifted in an alternating manner with chest compressions. When training in the use of ACD CPR, the invention can utilize an assistance device to assist in actively lifting the chest in an alternating manner with chest compressions. For example, one type of assistance device that can be used is a Cardiopump™ assistance device, commercially available from Ambu International. Such an assistance device is also described in U.S. Pat. No. 5,645,522, the complete disclosure of which is herein incorporated by reference. Other CPR methods that involve chest compressions can also be utilized in conjunction with the invention.

One aspect of the present invention provides a CPR training device which provides immediate feedback regarding the intrathoracic pressure during the CPR procedure. In this manner, the present invention provides significant advantages over conventional CPR training devices by providing pressures within the intrathoracic cage during both compression and decompression cycles. As used herein, the term “decompression” includes both passive and active decompression, i.e., lifting. In one particular embodiment, the present invention permits the training device to be coupled with a computer or a display system for providing feedback and tracking training results. Thus, the training devices of the present invention provides the trainee with immediate feedback regarding the proper method of performing CPR. In this way, the invention provides significant advantages over prior art CPR training mannequins by its ability to interface with a computer to provide feedback and track training results.

The devices of the present invention may comprise a flexible structure and a pressure sensor that is located within the flexible structure and is configured to measure the pressure within the flexible structure. The space within the flexible structure simulates an intrathoracic region, and therefore measuring pressures within the flexible structure during compression and decompression cycles simulates pressures within the intrathoracic region of a patient. In one particular embodiment, the pressure sensor measures the change in pressure within the flexible structure relative to ambient or atmospheric pressure.

A variety of methods and devices can be used to measure pressure within the flexible structure. For example, the pressure sensor may comprise a transducer which is operatively connected to a controller. When the flexible structure is compressed or lifted, the transducer generates a signal, e.g., in the form of electrical current or resistance. Conveniently, the controller can include circuitry to detect the signal generated by the transducer and to calculate the pressure change relative to the rest state of the flexible structure. In some cases more than one pressure sensor may be used to increase the range of measured pressures.

In some cases, the controller may be used to alter the measured pressures in order to have them more accurately reflect pressures that would be generated in a human chest. In other cases, a valve system may be used to produce a similar effect as described hereinafter. Both approaches may also be used together. The controller may modify the pressure readings based on empirical data obtained when performing CPR on human patients. An algorithm may then be used to covert the measured signal to a simulated signal based on the empirical data. For example, if a pressure of 100 cm H₂O was measured when pressing the flexible structure, and an expected pressure would be 70 cm H₂O, the controller may be used to modify the measured signal to 70 cm H₂O. In some cases, a simple calibration technique may be used to perform the conversion. By using empirical data, the devices of the invention may also be used to simulate different patient sizes.

The transducer can be configured such that it generates a positive or a negative signal depending on whether the flexible structure is compressed or lifted. In this manner, the controller can determine whether the pressure inside the flexible structure is positive or negative relative to the pressure within the flexible structure at rest.

In cases where the flexible structure does not produce negative pressures when relaxed or actively lifted (such as with a sealed bladder), the controller may be further operatively linked to a sensor that can detect whether the flexible structure is being compressed or relaxed (or actively lifted). Such a sensor may comprise a flexible member having material with an electrical resistance that changes upon bending of the flexible member. In this manner, the controller may be configured to alter the pressure reading based both on empirical data as well as whether the flexible structure is being compressed or relaxed. For example, if the flexible sensor indicates that the flexible structure is being relaxed, the controller may perform a calculation to determine the appropriate negative pressure to assign to the measured value.

Such flexible member sensor may be configured to generate one type of signal (e.g., increase in electrical signal) when it is bent one way and generate another signal (e.g., decrease in electrical signal) when it is bent the other way. In this manner, the controller can readily determine whether the pressure within the flexible structure is positive or negative. A variety of materials can be employed to produce the change of voltage based on the deflection of the flexible member, including, for example, resistive inks, strain sensitive polymers, and the like. Examples of materials that can be used are also described in U.S. Pat. Nos. 5,086,785, 5,157,372 and 5,309,135, the complete disclosures of which are herein incorporated by reference. Alternatively, a barometer can be placed within the flexible structure, e.g., bladder, to directly measure intrathoracic pressure. In one particular embodiment, the flexible member is a layer of strain sensitive polymer that experiences a change of electrical resistance when the flexible member bends. Typically, the flexible member is disposed within the area of compression/decompression so that the flexible member will bend upon compression or lifting by a person simulating CPR.

The device can further include a pressure display system to provide a visual reading of intrathoracic pressure during the compression and decompression stages of CPR administration. As stated above, the pressure sensor is preferably operatively connected to a controller, e.g., computer, which calculates the relative pressure within the flexible structure as described above. In this manner, the pressure display system displays a positive pressure during the compression stage and a negative pressure during lifting of the flexible structure. As used herein, the terms “negative pressure” and “positive pressure” refers to pressure within the flexible structure, which simulates intrathoracic region, relative to the pressure within the flexible structure at rest or the ambient or atmospheric pressure.

In another aspect of the present invention, the flexible structure may be coupled to one or more valve systems, such as those described in the above incorporated related applications. The valve systems in one aspect may be generally designed to simulate the patient's natural resistance to compression and decompression during CPR procedures. In another aspect, the valve systems may be configured to augment or enhance the amount of pressure generated in the flexible structure during pressing and/or actively lifting. In some embodiments, both types of valve systems may be used in series. As used herein, the term “valve” or “valve system” refers to a flow restrictive or limiting member, such as a flow restrictive orifice disposed within or connected in series with the flexible structure, or a pressure-responsive valve that impedes the inflow of air to and/or from the flexible structure.

The valve system may be attached directly to the flexible structure or to an airway that is coupled to the flexible structure. Conveniently, the valve system may alternatively be attached to an endotracheal tube or face mask that is coupled to the mannequin. By configuring the valve system, the device can be made to simulate a variety of different patient sizes. Alternatively, as discussed above, different patient sizes may also be simulated by manipulating the pressure calibration data using the controller.

In certain embodiments, the training devices of the present invention may simulate the thoracic tensions and recoil properties of a human thoracic cage during CPR compression and, optionally, decompression cycles. In this way, the training devices of the present invention simulate intrathoracic cage pressures during both compression and decompression cycles.

The invention can also provide the ability to record and store information regarding an individual's performance of CPR. This can be accomplished, for example, by providing a computer interface to permit the training device to be coupled to a computer. Alternatively, the training device can include an on board computer to record such information. The stored information can include information on intrathoracic pressure during CPR training, how the trainee presses and/or lifts during CPR training, the duration of training, the coordination of breathing with pressing and/or lifting, the application of a defibrillating shock, and the like.

To simulate thoracic tensions and recoil properties of a human thoracic cage, the invention in one embodiment provides an inflatable (or pre-inflated) bladder (i.e., flexible structure) that is disposed beneath a flexible cover or compression platform. The bladder is inflated to flex the cover until assuming the morphology of a human thoracic cage. The trainee then performs CPR by pressing down on the compression platform and, optionally, actively lifting the compression platform as if the trainee were performing ACD CPR on a human patient. The pressure produced within the compression compartment while performing CPR is displayed in real time. In this way, the trainee is able to visualize the positive and negative intrathoracic pressures created while performing CPR. The invention can also be employed to visually display in real time the distance of compression and/or elevation while performing CPR. This information can be obtained from an excursion sensor. If the pressures generated or the distance moved exceeds certain ranges, an alarm may be produced to notify the trainee of the improper technique.

In one optional aspect, a breathing tube may extend from the training device in such as way as to simulate a patient's neck. Conveniently, the tube can be expandable and compressible for easy storage when not in use. The end of the tube can include a mouthpiece where the trainee can place their mouth to simulate mouth to mouth resuscitation. Alternatively, the end of the tube can include an air bag that is squeezed by the trainee. Optionally, a flow sensor can be provided in the tube to sense when the trainee delivers a volume of a respiratory gas. This information can be sent to a controller to maintain a record of the timing of delivery (particularly in relation to chest compressions), the duration, the volume, and the like.

Another feature of the invention is that the training device can be housed in a portable carrying case. In this way, the training device can conveniently be carried to training locations. When ready to begin training, the carrying case is placed on a flat surface, opened, and the bladder is inflated.

The present invention will now be described with regard to the accompanying drawings which assist in illustrating various features of the invention. It should be appreciated that the drawing are provided for the purpose of illustrating the practice of the present invention and do not constitute limitations on the scope thereof.

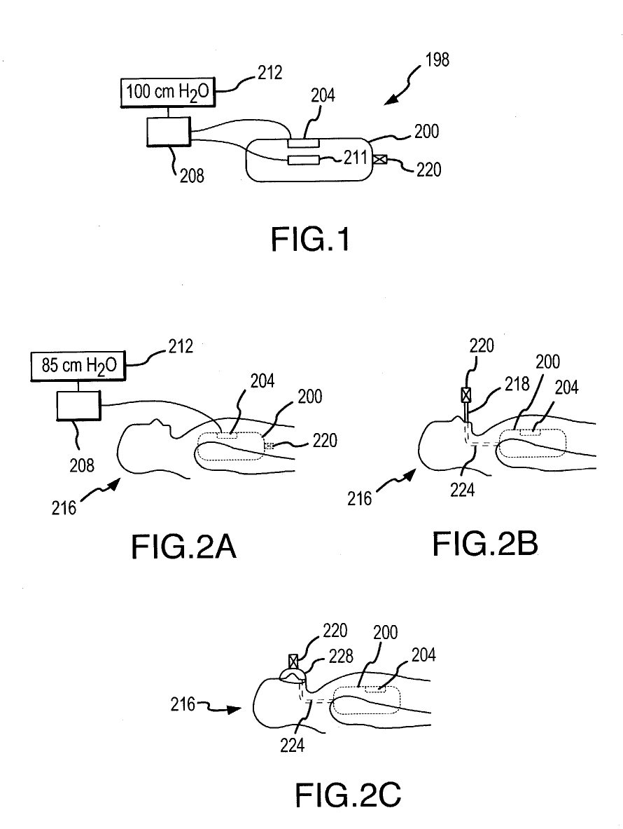

Referring to FIG. 1, one embodiment of a CPR training device 198 will be described. Device 198 comprises a flexible structure 200 and a pressure sensor 204. The pressure sensor 204 can be operatively connected to a controller system 208, which determines the pressure changes within the flexible structure 200. Changes in pressure are displayed on a display system 212, which can be a separate system or an integral part of the controller system 208. When a transducer is used as a pressure sensor, the pressure within the flexible structure 200 can be calculated by measuring the signal generated by the transducer.

A variety of flexible structures may be used to simulate the thoracic cavity. For example, the flexible structure may be a sealed bladder, or may have an opening to permit fluids to enter and exit during a training procedure. The flexible structure may be constructed to have recoil properties so as to have a feel that resembles the human chest when performing CPR, such as with other embodiments described herein. Typically, the flexible structure will be filled with air, although other fluids may be used as well. If a sealed structure is used, the structure may be pre-inflated, or may have an airway to permit inflation. The pressure sensor may be located somewhere within the flexible structure, and may be coupled to a wall as shown in FIG. 1.

The pressures displayed on the display system 212 may be relative to the pressure of the flexible structure 200 at rest state or the ambient or atmospheric pressure. Typically, the controller system 208 is calibrated or otherwise configured such that the pressure within the flexible structure 200 at rest reads zero. The controller system is then programmed to calculate, either based on empirical data, actual measurements or other criteria, a pressure that simulates a pressure that would be generated in a human when performing CPR. For example, during training the trainee may be instructed to press and release (or lift) the flexible structure using forces that are similar to those used on a real person. If needed, the pressure reading is converted to a value that is similar to what would be generated in a human chest using the same forces.

Optionally, a valve system 220 may be directly or indirectly coupled to flexible structure 200. Valve system 220 may regulate fluid flow into and out of flexible structure in order to generate pressures similar to those found in a human chest and may be similar to the valve systems described herein. In such cases, controller 208 may not need to convert the pressure readings as previously described.

In cases where flexible structure 200 is a sealed system, a sensor 211 may be used to determine whether flexible structure 200 is being compressed or relaxed (or actively lifted). Sensor 211 is configured to determine the direction of flexing in order to determine whether flexible structure 200 is being compressed. Based on the reading of sensor 211 and pressure sensor 204, controller 208 may be programmed to determine a simulated pressure to display using display system 212. For example, if sensor 211 determines that flexible structure 211 is being actively lifted, and sensor 204 reads a pressure of 20 cm H₂O, controller 208 may be configured to display a pressure of −50 cm H₂O.

As shown in FIG. 2A, the flexible structure 200 may be placed within a mannequin 216 to simulate a human body for CPR training. As previously described, flexible structure 200 may be a sealed bladder or may include a valve system 220.

In some embodiments, an airway 224 may extend between flexible structure 200 and a mouth of mannequin 216 as shown in FIGS. 2B and 2C. In such cases, valve system 220 may be couple to a coupling device that couples valve system 220 to airway 224. For example, as shown in FIG. 2B, valve system 220 may be coupled to an endotracheal tube 218 that is inserted by the trainee into airway 224. As shown in FIG. 2C, valve system 220 may be coupled to a face mask 228 that is placed on the mannequin's face so as to cover the mouth. By using valve 220 in this manner, the pressures generated within flexible structure may be similar to those experienced when performing CPR on a real patient. Further, it will be appreciated that valve system 220 may be placed at other locations, such as to flexible structure 200 as previously described.

In some cases, it may be desirable to configure valve system 200 so that it augments or enhances both positive and/or negative pressures within flexible structure 200 in a manner similar to that described in the patents previously incorporated by reference. This may be accomplished, for example, by increasing the resistance to air inflow and/or outflow. In this way, the trainee may be able to evaluate whether she is performing CPR in a proper manner when using valve system 220 to augment the intrathoracic pressures.

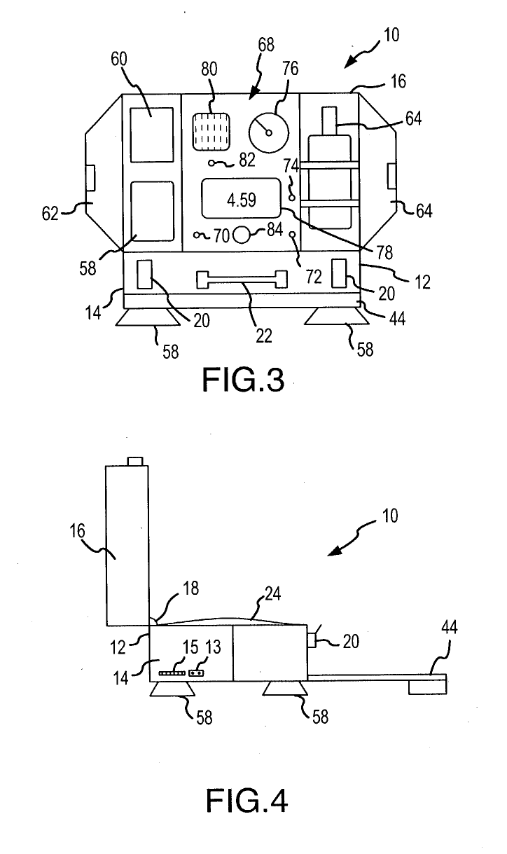

Referring to FIGS. 3 and 4, one embodiment of a CPR training device 10 will be described. Training device 10 comprises a portable carrying case 12 that is constructed of a compression compartment 14 and a control compartment 16. Carrying case 12 may be constructed of a generally rigid material and may have the overall size and shape of a conventional briefcase. In this way, training device 10 is compact in nature, thereby providing portability during travel and a reduction in training space requirements.

Compression compartment 14 is coupled to control compartment 16 by a hinge 18 to permit carrying case 12 to be opened and closed in a manner similar to a conventional briefcase. Conveniently, latches 20 can be provided to latch control compartment 16 to compression compartment 14 when in the closed position. A handle 22 can also be provided to facilitate carrying of carrying case 12.

Carrying case 12 can optionally include a power supply interface 13 to permit device 10 to be coupled to an external power source. Further, a computer interface 15 can be provided to permit device 10 to be coupled to an external computer. In this way, various data obtained using device 10 can be recorded and processed. Optionally, interface 15 can be used to permit device 10 to be coupled to any type of network, such as the internet, to facilitate data transfer.

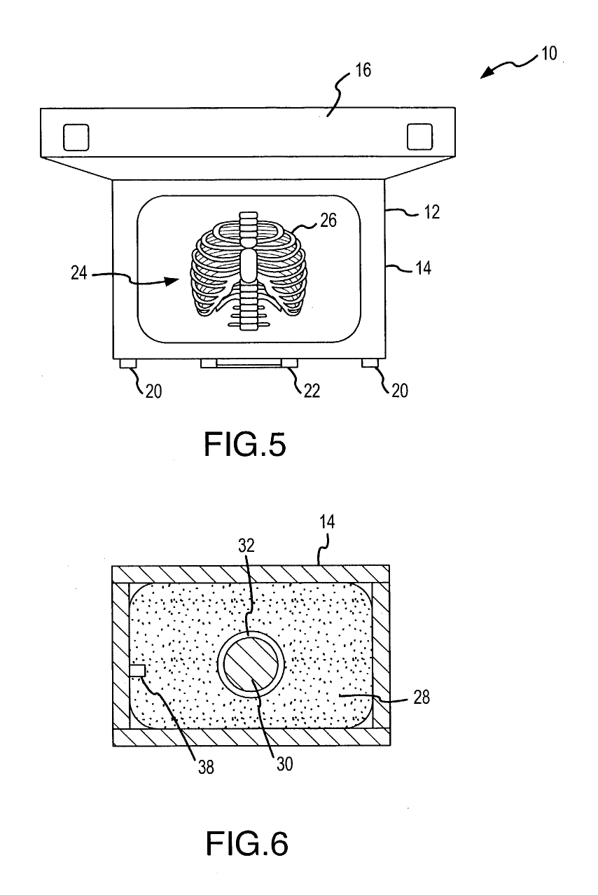

As also shown in FIG. 5, compression compartment 14 houses a compression platform 24. Compression platform 24 can be constructed of a durable and flexible material that can withstand repeated compressions and elevations. Optionally, compression platform 24 can include a diagram or image 26 of a human chest, thoracic cage, or other anatomical depictions to assist in proper positioning of an assistance device or the trainer's hands while performing CPR. Compression platform 24 can be sealed to compression compartment 14 to create an enclosed air-tight cavity beneath compression platform 24. By providing a sealed environment within compression platform 24, the pressure anywhere within compression platform 24 can be measured when performing chest compressions and decompressions as described below in order to provide positive and negative “intrathoracic” pressure measurements.

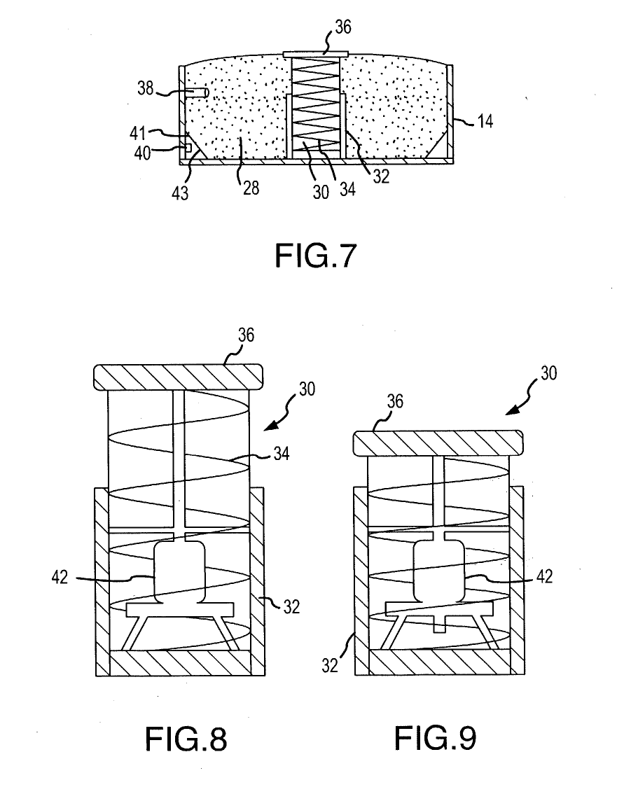

As shown in FIGS. 6 and 7, compression compartment 14 includes an inflatable bladder 28 that is housed beneath compression platform 24. Bladder 28 can also be made from a durable and flexible material that can withstand repeated inflations prior to use, compressions and expansions during use, and deflation after use. When inflated, bladder 28 expands compression platform 24 to the morphology of a human thorax. FIG. 4 illustrates compression compartment 14 when bladder 28 has been inflated. When inflated, bladder 28 can be used to simulate the tension of a human thorax during chest compressions and the recoil properties of a human thorax during chest decompressions or elevations.

A spring-loaded piston system 30 can also be placed within compression compartment 14 to provide additional simulation of human thoracic tensions and recoil properties. Piston system 30 comprises a housing 32 that houses a spring 34. Piston system 30 further includes a translatable piston member 36. Piston system 30 is centrally located within compression compartment 14, with bladder 28 surrounding piston system 30. When compression platform 24 is pressed downward, piston member 36 is moved downward to compress spring 34 as illustrated in FIG. 9. When the downward pressure is released from compression platform 24, the pressure within bladder 28, along with spring 34, forces compression platform 24 back to its normal position as illustrated in FIG. 8. When platform 26 is pulled upward, such as with an adjunctive CPR device, the spring loaded piston is extended upward. A sensor (not shown) may be employed to determine the extent of compression or extension of the spring relative to the normal position. This information may then be sent to the controller.

As shown in FIG. 7, a compressed air inflate/deflate port 38 is provided in compression compartment 14 to permit bladder 28 to be inflated and deflated. As described in greater detail hereinafter, a source of compressed gas can be coupled to port 38 to permit bladder 28 to be inflated. Alternatively, bladder 28 can be inflated by providing a mechanical hand or foot pump, an electric air pump, or by blowing up bladder 28 by mouth.

Compression compartment 14 further includes a pressure sensing port 40 through which a pressure sensor can be positioned. A shield 41 is provided within the compression compartment to form a compression cavity 43. Shield 41 protects the pressure sensor from bladder 28 during the compression phase while permitting compression cavity 43 to remain in fluid communication with the rest of the compression compartment 14. Since compression platform 24 (see FIG. 4) creates an air tight seal with compression compartment 14, the pressures measured by the pressure sensor within compression cavity 43 are identical to the pressures within compression compartment 14. Hence, the pressure sensor can be used to measure the amount of positive intrathoracic pressure during chest compressions and the amount of negative intrathoracic pressure during chest decompressions and elevations. A variety of pressure sensor or force transducing devices can be employed to measure the pressure in this manner. As described in greater detail hereinafter, the pressure sensing device can be coupled to a pressure gauge or other type of display to visually display the sensed pressure.

Also housed within housing 32 is a linear variable differential transformer (LVDT) 42 to provide the trainee with the thoracic distance traveled during compression, decompression or elevation cycles as illustrated in FIGS. 8 and 9. More specifically, LVDT 42 measures the distance traveled by piston member 36 as compression platform 24 is pressed or lifted. Although a LVDT is shown, it will be appreciated that other devices can be employed to measure the linear distance traveled by compression platform 24 during compression or elevation cycles, including encoders, optical sensors, magnetic switches, and the like.

As shown in FIGS. 4, 10 and 11, training device 10 further includes a kneel plate 44 which is provided to allow a trainee to comfortably kneel in front of carrying case 12 when performing CPR. When kneeling on kneel plate 44, carrying case 12 is stabilized and prevents compression compartment 14 from being lifted during chest elevations. Kneel plate 44 may optionally include a foam or other resilient surface to provide padding for the trainee's knees.

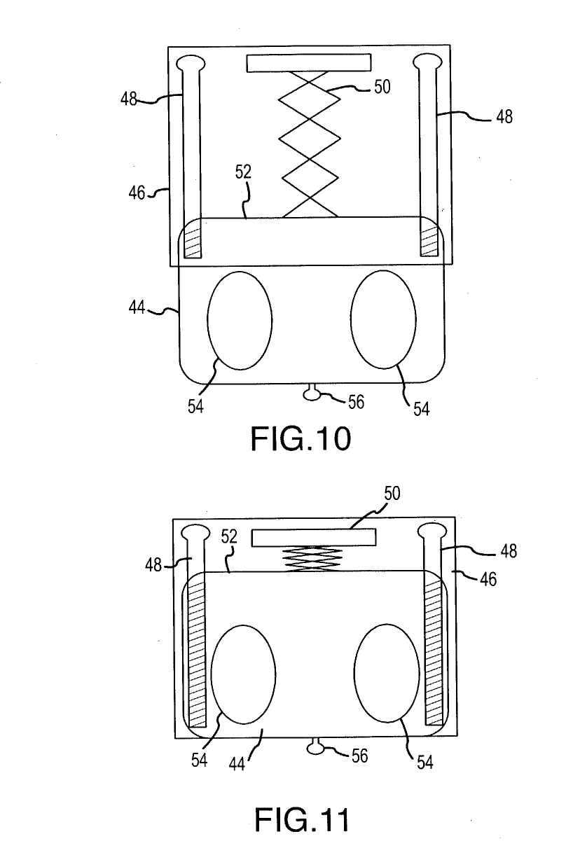

Kneel plate 44 is positioned beneath compression compartment 14 and is housed within a case frame 46. Housed in case frame 46 is a pair of support rails 48 to assist and guide kneel plate 44 when it is moved between an extended position (see FIG. 10) and a retracted position (see FIG. 11). A scissors mechanism 50 can also be provided to give additional stability and to provide assistance when extending and retracting kneel plate 44. Optionally, a load support rod 52 can be coupled to kneel plate 44 to facilitate coupling between scissors mechanism 50 and kneel plate 44. Conveniently, knee pads 52 can be provided on kneel plate 44 to provide a comfortable resting place for the trainee's knees. Optionally, a knob 56 can be provided to assist the user in extending and retracting kneel plate 44. As shown in FIGS. 3 and 4, carrying case 12 can optionally include suction feet 58 on compression compartment 14 to prevent carrying case 12 from rising during chest elevations.

Referring back to FIG. 3, construction of control compartment 16 will be described. Control compartment 16 includes a rechargeable power source 58 to provide electrical current to the various electrical components within training device 10. For example, power source 58 provides power to a circuit board 60 having a controller that in turn is employed to control the various sensors, gauges, alarms, displays, metronome, and the like, of training device 10. The controller can optionally be coupled to an external computer using interface 15 as previously described. In this way, a permanent record relating to the rescuer's performance can be made. For example, the controller can be used to generate and transmit data tracking the timing and extent of compression and/or decompression, the generated pressures, the duration of training, and the like. Optionally, the attached (or integrated) computer can include software to permit the entry of the trainee's name so that the transmitted information can be linked to a specific trainee. In cases where the training device also permits the simulation of ventilations and/or defibrillating shocks, this information can also be sent to the external computer. In this way, feedback can further be provided on the timing and length of ventilations as well as the application of the defibrillating shock. The computer can also be used to produce a graphical display on a display screen summarizing the evaluation. For example, the display may include a graph showing when the compressions/decompressions and ventillations were performed. This information can be superimposed on, or placed adjacent to, a graph having recommended actuation times. In a similar manner, graphical depictions can be produced showing the magnitude and duration of compressions/decompressions and ventilations.

Conveniently, a door 62 is provided to enclose circuit board 60 and power source 58. The opposite side control compartment 16 includes an optional compressed air tank 64 that is coupled to port 38 (see FIGS. 6 and 7) to supply compressed air to bladder 28 to inflate the bladder as previously described. Conveniently, a door 66 is provided to enclose air tank 64. Although shown with an air tank, it will be appreciated that other inflation equipment can be used including a mechanical hand or foot pump, an electric air pump, and the like. Further, in some cases bladder 28 can be inflated by blowing up bladder 28 by mouth, thereby eliminating the need for an inflation device.

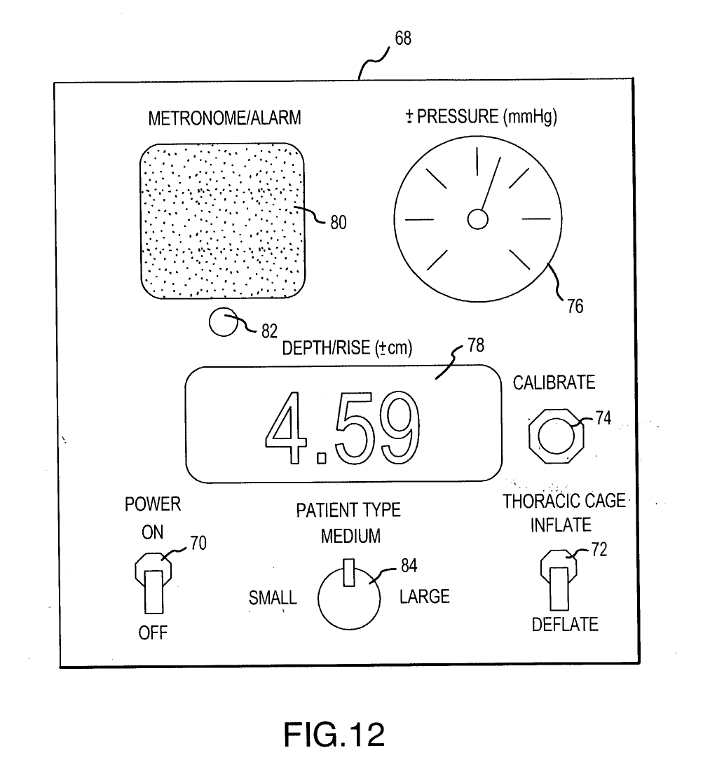

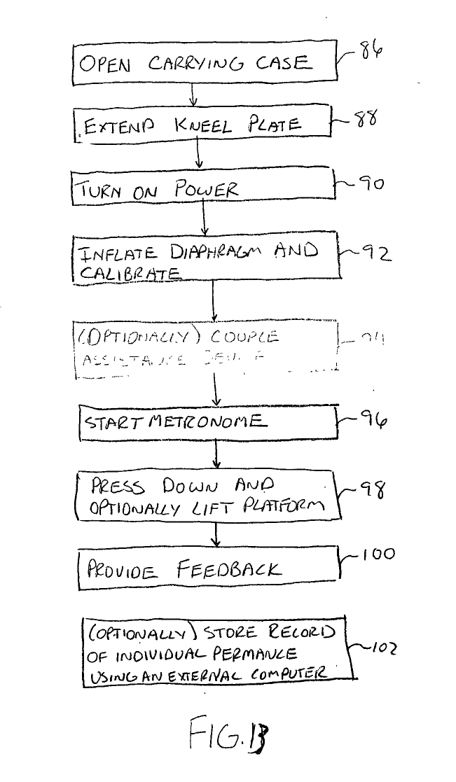

As also shown in FIG. 12, control compartment 16 includes a display panel 68. Display panel 68 includes a power switch 70 that is movable between an on and an off position. When turned to the on position, power from power source 58 is available to the various electrical components of training device 10. An inflate/deflate switch 72 is also provided on display panel 68. When switch 72 is moved to the inflate position, compressed air from air tank 64 is supplied to bladder 28 to inflate the bladder. When moved to the deflate position, the air within bladder 28 is released through port 38 so that carrying case 12 may be closed and transported. A calibrate switch 74 is also provided to calibrate the system prior to performing CPR. More specifically, after bladder 28 is inflated, calibration switch is pressed to calibrate the distance sensor within compression compartment 14 to a baseline or starting value.

A pressure gauge 76 is provided on display panel 68 and is coupled to circuit board 60 which in turn is coupled to the pressure sensor within compression compartment 14. In this way, the pressure within compression cavity 43 can be monitored and displayed in real time. Hence, as the trainee kneels in front of display panel 68, the user is able to see the positive and negative intrathoracic pressures created when performing CPR. Similarly, a compression/decompression gauge 78 is provided to display the distance at which compression platform 24 is pressed or lifted relative to the calibrated value. It will be appreciated that gauges 76 and 78, as well as any other feedback mechanisms, can be entirely analog gauges, entirely digital gauges, or a combination of either technology.

Display panel can further include a speaker 80 that is electrically coupled to circuit board 60. In this way, an audible alarm can be produced if the pressures created within compression cavity 43 or the distance traveled by compression platform 24 are outside of certain ranges. Merely by way of example, an alarm may be produced if the measured force is greater than about 300 N to about 400 N during chest compressions and exceeds about −200 N to about −300 N during chest decompressions or elevations. Similarly, an alarm may be produced if the distance compressed is greater than about 6 cm to about 8 cm during chest compressions or exceeds about 4 cm to about 8 cm when performing chest decompressions or elevations. It will be appreciated that these ranges are contingent upon the patient size as described below. Optionally, a flashing light 82 can also be provided as an additional alarm.

Circuit board 60 can also include circuitry to provide the function of an electrical metronome. In this way, a regular rhythm can be produced with speaker 80 to assist the trainee in performing regular chest compressions and/or elevations. Further, display panel 68 can include a patient type switch 84 which allows the trainee to select a particular patient build, i.e., small, medium, or large. This setting is used to determine appropriate pressure and distance ranges that must be exceeded before an alarm will be produced as previously described.

Although device 10 is shown with various sensors and displays, it will be appreciated that simplified versions of device 10 are also possible. For example, training device 10 can be constructed of a carrying case, a bladder that is manually inflatable and deflatable, and a kneel plate.

In another alternative, device 10 can include appropriate electrical shielding so that a defibrillating shock can be applied to compression platform 24 without damaging the electrical components or injuring the trainee. When modified in such a manner, the training device can include a ground plate and an adjunctive CRP device having defibrillating electrodes to supply the defibrillating shock. Types of adjunctive CPR device that can be used (and modified to include electrodes, if needed) are described in U.S. Pat. Nos. 5,454,779 and 5,645,552, and in copending U.S. patent application Ser. Nos. 09/197,286, filed Nov. 20, 1998, Ser. No. 09/095,916, filed Jun. 11, 1998 and Ser. No. 09/315,396, filed May 20, 1999, the complete disclosures of which are herein incorporated by reference.

Referring now to FIG. 13, one training method utilizing CPR training device 10 will be described. Initially, the user carries the carrying case to a smooth, flat surface and engages the suction feet. The carrying case is then opened as illustrated in step 86 and kneel plate 44 is extended as shown in step 88. Power switch 70 is then turned to the “on” position as shown in step 90 and switch 72 is switched to the “inflate” position to inflate bladder 28. Circuit board is preferably programmed so that a predetermined amount of gas is supplied to bladder 28. Once the bladder is inflated, the user presses calibrate button 74 to calibrate the training device as illustrated in step 92. When calibrate button 74 is pressed, the compression/decompression gauge 78 is configured to read zero. The user then selects the particular patient type using switch 84. Conveniently, pressure gauge 76 can be configured to read zero when the bladder is inflated to the proper volume. In some cases, pressure gauge 76 can also be configured to be calibrated when calibrate button 74 is pressed.

As shown in step 94, the user may optionally couple an assistance device to compression platform 24. The user may then kneel on kneel plate 44, with the user's knees resting on knee pads 54. Standard CPR or ACD CPR can then be performed as if the trainee were practicing on a real patient as shown in step 98. Speaker 80 may be employed to perform a metronome function to assist the user in performing regular chest compressions or elevations as shown in step 96. Optionally, light 82 may be lighted according to the same rhythm produced by speaker 80. When placing the user's hands or the assistance device onto compression platform 24, diagram 26 may be referred to ensure proper placement.

When performing CPR, the user may observe the depth of compression or height of elevation and the produced pressure by evaluating gauges 78 and 76, respectively. This permits the user to attempt to stay within predetermined guidelines determined by CPR standards for the appropriate patient frame size. Audio and/or visual alarms may be produced by speaker 80 or light 82 if the user exceeds the guideline parameters as shown in step 100. Optionally, as shown in step 102, feedback on the trainee's performance can be stored using an external computer (or an onboard computer, if provided). As another option step, simulated ventilations can periodically be provided and appropriate feedback generated and displayed.

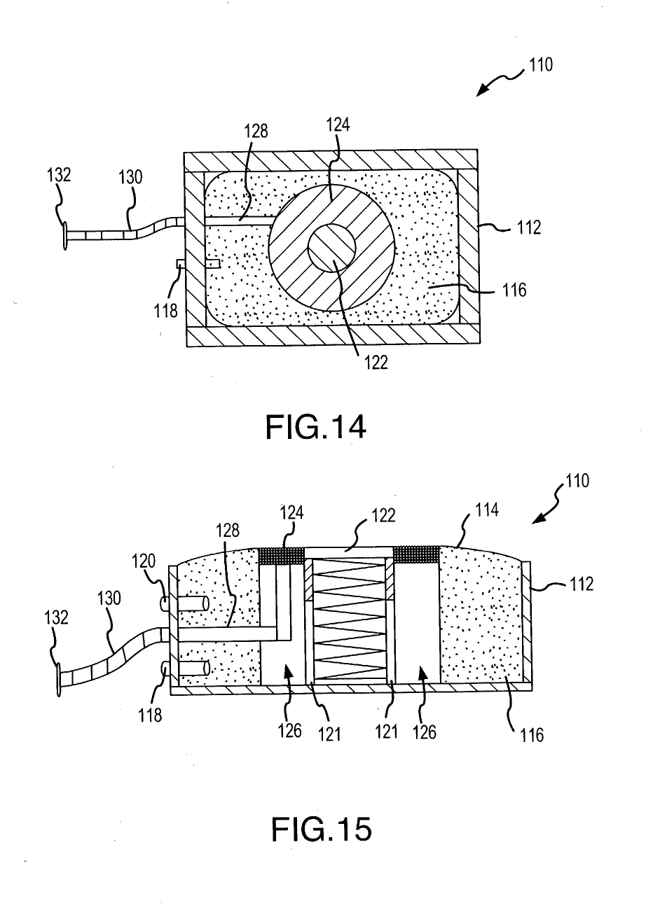

Referring now to FIGS. 14 and 15, and alternative embodiment of a training device 110 will be described. Device 110 is similar to device 10 and can conveniently use similar sensors, a similar controller, a similar kneel plate, a similar compression platform, among other components. Device 110 comprises a carrying case 112 having a compression platform 114. Held within carrying case 112 is a thoracic cavity bladder 116 that may be inflated and deflated through an inflate/deflate port 118. A pressure sensing port 120 is also provided to permit pressure measurements to be taken in a manner similar to that described with device 10. A spring housing 121 houses a spring piston 122 that is compressed and extended when performing CPR training in a manner similar to device 10.

Device 110 further includes a lung bladder 124 that is positioned on a lung bladder mount platform 126. A lung inflate/deflate port 128 is coupled to lung bladder 124 to permit inflation and deflation of bladder 124. Bladder 124 is used to simulate a patient's lungs. Coupled to port 128 is a length of collapsible tubing 130 having a mouthpiece 132. These components are configured to simulate a patient's neck a mouth so that a trainee may practice ventilating the patient using mouth to mouth resuscitation techniques. Alternatively, a ventilatory bag can be used in place of mouthpiece 132 to permit the trainee to practice ventilations by squeezing the bag. Conveniently, tubing 130 is collapsible and/or removable to facilitate storage of device 110.

The controller within device 110 can be used to generate a signal to indicate when to provide ventillations in relation to chest compressions. Further a pressure or other sensor may be used to sense the flow of gases and the pressure within bladder 124. In this way, feedback can be provided as to the proper performance of ventillations in connection with a CPR procedure. As with other embodiments, this information may be transmitted to an external or onboard computer.

The invention has now been described in detail for purposes of clarity and understanding. However, it will be appreciated that certain changes and modifications may be practiced within the scope of the appended claims. For example, in some cases the training device may include all mechanical components so that a power supply or electronics are not needed. For instance, a spring strain gauge may be employed to assess the extent of compression and decompression. Also, a mechanical pump may be used to inflate the bladder.

What is claimed is:

1. A CPR training device, comprising:
a flexible structure that contains a fluid and that is configured to simulate a human chest; and
a pressure sensor disposed within said flexible structure, wherein said pressure sensor is configured to sense both positive and negative pressures with respect to atmospheric pressure within said flexible structure.

2. The CPR training device of claim 1, further comprising a controller coupled to the pressure sensor, and a display coupled to the controller for displaying pressures sensed by said pressure sensor.

3. The CPR training device of claim 1, further comprising a valve system operably coupled to an opening in said flexible structure, wherein said valve system is configured to regulate inflows into the flexible structure and outflows from the flexible structure to help simulate pressure changes experienced within a human chest cavity during CPR procedures upon pressing and lifting of the flexible structure.

4. The CPR training device of claim 3, further comprising a human mannequin, and wherein said flexible structure is coupled to said mannequin.

5. The CPR training device of claim 4, wherein said mannequin includes a mouth and an airway extending between the flexible structure and the mouth.

6. The CPR training device of claim 5, further comprising a face mask that is placeable over the mouth of the mannequin, and wherein said valve system is coupled to said face mask.

7. The CPR training device of claim 5, further comprising an endotracheal tube that is insertable into the airway of the mannequin, and wherein said valve system is coupled to said endotracheal tube.

8. The CPR training device of claim 1, wherein the flexible structure comprises a bladder containing the fluid.

9. The CPR training device of claim 8, wherein said bladder is a closed system.

10. The CPR training device of claim 1, wherein the fluid comprises air.

11. The CPR training device of claim 1, wherein the pressure sensor is configured to sense pressures in the range from about −200 cm H₂O to about 200 cm H₂O with respect to the pressure within the flexible structure at rest or relative to atmospheric pressure.

12. The CPR training device of claim 2, wherein the controller is configured to alter pressure readings from the pressure sensor such that pressures displayed on the display are similar to pressures that would be experienced in a human chest when performing CPR procedures.

13. The CPR training device of claim 1, further comprising a metronome to assist in the performance of regular compressions and decompressions of the compression platform.

14. The CPR training device of claim 1, further comprising an alarm to produce an audio and/or visual signal if the pressure within the flexible structure is outside of a certain range.

15. A CPR training system, comprising:
a CPR training device comprising a flexible structure that contains a fluid and that is configured to simulate a human chest, and a pressure sensor disposed within the flexible structure, wherein the pressure sensor is configured to sense both positive and negative pressures with respect to the pressure within the flexible structure at rest or relative to atmospheric pressure; and
an adjunctive CPR device that is adapted to be placed over the flexible structure to permit the flexible structure to be pressed and released or actively lifted by a trainee.

16. A CPR training method comprising:
providing a CPR training device comprising a flexible structure that contains a fluid and that is configured to simulate a human chest, and a pressure sensor disposed within the flexible structure, wherein the pressure sensor is configured to sense both positive and negative pressures with respect to the pressure within the flexible structure at rest or relative to atmospheric pressure;
repeatedly pressing and releasing the flexible structure in an alternating manner to simulate the performance of closed chest manual CPR;
measuring pressures created within the flexible structure during pressing and releasing of the flexible structure; and
displaying the measured pressures.

17. The method of claim 16, wherein the CPR training device further comprises a valve system operatively interconnected to an opening of the flexible structure, and further comprising regulating inflows into the flexible structure and outflows from the flexible structure to help simulate pressure changes experienced within a human chest cavity during CPR procedures upon pressing and releasing of the flexible structure.

18. The method of claim 17, wherein the CPR training device further comprises a human mannequin, and further comprising pressing and releasing a chest of the mannequin to press and release the flexible structure.

19. The method of claim 18, wherein the valve system is coupled to a face mask, and further comprising coupling the face mask over the mouth of the mannequin.

20. The method of claim 18, wherein valve system is coupled to an endotracheal tube, and further comprising coupling the endotracheal tube to an airway of the mannequin.

21. The method of claim 16, wherein said step of releasing the flexible structure further comprises lifting the flexible structure.

22. The method as in claim 21, wherein the pressing and lifting step comprises placing an adjunctive CPR assistance device onto the flexible structure and pressing and lifting the CPR assistance device in an alternating manner.

23. The method of claim 16, further comprising recording pressure readings in a controller, and graphically displaying the pressure readings on a display screen that is coupled to the controller.

24. The method of claim 23, further comprising altering the pressure readings from the pressure sensor with the controller such that pressures displayed on the display are similar to pressures that would be experienced in a human chest when performing CPR procedures.
